(19) United States
(12) Patent Application Publication
(10) Pub. No.: US 2019/0361859 A1
(43) Pub. Date: Nov. 28, 2019

(54) Structured system for progressing of entities' assigned positions into the next successive higher levels of progression in a self-compacting relational multi-level tree system

(71) Applicant: Cheng Kang, Compass YAP, Singapore (SG)

(72) Inventor: Cheng Kang, Compass YAP, Singapore (SG)

(21) Appl. No.: 16/442,547

(22) Filed: Jun. 17, 2019

Related U.S. Application Data
(63) Continuation-in-part of application No. 14/429,785, filed on Mar. 20, 2015, now Pat. No. 10,325,208.

(30) Foreign Application Priority Data
Sep. 24, 2012 (SG) PCT/SG2012/000356

(51) Int. Cl. G06F 16/22; G06F 17/18

(52) U.S. Cl. CPC G06F 16/2246; G06F 17/18; G06F 16/2272

(57) ABSTRACT

Embodiments generally relate to structured methods and systems for effecting fair distributions to the entities in a relational multi-level tree system. An optimal number of age range interval tabulations (ARIT) may be defined corresponding to levels of an age ranges tabulation data structure of the relational multi-level tree system including a plurality of structured adjacent flat-top multi-level trees. The contributing entities are pre-sorted to form an ordered age priority sequence and assigned into a single flat-top multi-level tree or multiple adjacent flat-top multi-level trees by applying top/down or adjacent-top/down assignment in a respective age ARIT based on optimal size and measurement considerations made according to a level strength analysis chart (LSAC). The contributing entities' positions are periodically released and reassigned into a next successive higher position based on the contributing entities' age advancement. Fair distributions are accorded to the contributing entities based on their age-ordered assigned positions in the relational multi-level tree system.

### CROSS-REFERENCE TO RELATED APPLICATION

This application is a continuation-in-part application which claims the benefit of co-pending U.S. patent application Ser. No. 14/429,785 entitled “Relational Multi-level Tree Systems” filed on Mar. 20, 2015, the entire contents of which are herein incorporated by reference in its entirety for all purposes.

### BACKGROUND

Conventional multi-level tree systems have multi-levels. A lower level in a multi-level tree system may typically have a base which is larger than the level above. This phenomenon may be referred to as “a broadening base”. Conventional multi-level tree systems experiences exponentially broadening bases with each level downwards. Exponentially broadening bases makes determining the maximum base limits nearly impossible. The physics of the exponential increase in base entities within the conventional multi-level tree systems are practically inexhaustible. Filling the endlessly exponentially broadening bases of the conventional multi-level tree system with child entity assignments could require more than the world's population.

The problem with exponentially broadening base logic is that the exponentially incremental effects would get bigger at each level downwards. It may even start off with the smallest exponential increment of two, but it could come to a point of encounter whereby the next level of increment could result in obstacles of the next exponentially incremental effects. Therefore, besides broadening base effects, obstacles of the next exponentially incremental effects also exist in conventional multi-level tree systems. This is due to the physics of ever-enlarging base entities in conventional multi-level tree systems, especially when encountering with the next level of exponential incremental effects. When assigning the next level of child entities, the increase in each level downwards could cause the slowing down of the multi-level tree formation. The slowing down effects could get so slow that it is non-practical.

Besides these effects, the conventional multi-level tree system is non-structured and grows freely in lopsided patterns. They are prone to becoming unstable, which further becomes detrimental to later contributing entities assigned into a tree system. Further, conventional trees are posed with the challenge where top levels are filled with minority entities which indefinitely hold on to their position in the top level and child entities stick to their initially assigned positions. This leads to disproportionate and unfair distributions to entities in lower levels of the tree.

Therefore, there is a desire to provide a structured, self-compact relational multi-level tree system which accords fair distribution.

### SUMMARY

Embodiments generally relate to a structured method for forming a relational multi-level tree system and progressing entities' positions into next successive higher levels in the relational multi-level tree system for effecting fair distributions to the entities in the relational multi-level tree system. In one embodiment, the structured method includes providing entity information of contributing entities in a database. The entity information includes age information of the contributing entities. The method also includes defining, by a processor, based at least in part on the age information in the database, an optimal number of age range intervals corresponding to levels of an age ranges tabulation data structure of the relational multi-level tree system. The relational multi-level tree system includes flat-top multi-level trees in the age ranges tabulation data structure. The contributing entities are pre-sorted by the processor based on the age information in the database to form an ordered age priority sequence of contributing entities' positions in the relational multi-level tree system. The method also includes assigning, by the processor using the ordered age priority sequence, the pre-sorted contributing entities in their respective age range intervals which correspond to the levels in the age ranges tabulation data structure by the assignment of positions of contributing entities into the flat-top multi-level trees in accordance with a level strength analysis chart (LSAC). The LSAC includes level strength and level accumulative strength parameters. Assigning the pre-sorted contributing entities in a respective age range interval includes determining an optimal size of the flat-top multi-level tree and number of the flat-top multi-level trees required to be constructed within the respective age range interval based on a total number of contributing entities to be positioned in the respective age range interval and optimal size and measurement considerations made in accordance with the LSAC. The optimal size of the flat-top multi-level tree is a difference between accumulative strengths of two selected levels in the LSAC, and the number of the flat-top multi-level trees required to be constructed within the respective age range interval is computed by dividing the total number of contributing entities to be positioned in the respective age range interval by the optimal size of the flat-top multi-level tree. Assigning the pre-sorted contributing entities in a respective age range interval includes constructing a single flat-top multi-level tree or multiple adjacent flat-top multi-level trees within the respective age range interval based on the optimal size of the flat-top multi-level tree and number of the flat-top multi-level trees required to be constructed within the respective age range interval. Assigning the pre-sorted contributing entities in a respective age range interval further includes assigning the contributing entities into their respective positions in the single flat-top multi-level tree or multiple adjacent flat-top multi-level trees in the respective age range interval by applying top/down or adjacent-top/down assignment of positions of contributing entities respectively. The structured method also includes periodically releasing and reassigning, by the processor, contributing entities' positions into a next successive higher position in the age ranges tabulation data structure of the relational multi-level tree system during a position assignment reprioritizing process, based on an interval indication or during the contributing entities' age advancement. One or more contributing entities are graduated out of the relational multi-level tree system in the event the one or more contributing entities' age exceeds the defined age range intervals. Fair distributions are accorded by the processor to the contributing entities based on their age-ordered assigned positions in the relational multi-level tree system.

Another embodiment is directed to a relational multi-level tree system for effecting fair distributions to contributing entities positioned in the relational multi-level tree system. The relational multi-level tree system includes a database for retrieving entity information of the contributing entities and a processor. The entity information includes age information of the contributing entities. The processor is configured to define, based at least in part on the age information in the database, an optimal number of age range intervals corresponding to levels of an age ranges tabulation data structure of the relational multi-level tree system. The relational multi-level tree system comprises flat-top multi-level trees in the age ranges tabulation data structure. The processor is also configured to pre-sort the contributing entities based on the age information in the database to form an ordered age priority sequence of contributing entities' positions in the relational multi-level tree system. The processor assigns, using the ordered age priority sequence, the pre-sorted contributing entities in their respective age range intervals which correspond to the levels in the age ranges tabulation data structure by the assignment of positions of contributing entities into the flat-top multi-level trees in accordance with a level strength analysis chart (LSAC). The LSAC includes level strength and level accumulative strength parameters. Assigning the pre-sorted contributing entities in a respective age range interval includes determining an optimal size of the flat-top multi-level tree and number of the flat-top multi-level trees required to be constructed within the respective age range interval based on a total number of contributing entities to be positioned in the respective age range interval and optimal size and measurement considerations made in accordance with the LSAC. The optimal size of the flat-top multi-level tree is a difference between accumulative strengths of two selected levels in the LSAC, and the number of the flat-top multi-level trees required to be constructed within the respective age range interval is computed by dividing the total number of contributing entities to be positioned in the respective age range interval by the optimal size of the flat-top multi-level tree. Assigning the pre-sorted contributing entities in a respective age range interval includes constructing a single flat-top multi-level tree or multiple adjacent flat-top multi-level trees within the respective age range interval based on the optimal size of the flat-top multi-level tree and number of the flat-top multi-level trees required to be constructed within the respective age range interval. Assigning the pre-sorted contributing entities in a respective age range interval further includes assigning the contributing entities into their respective positions in the single flat-top multi-level tree or multiple adjacent flat-top multi-level trees in the respective age range interval by applying top/down or adjacent-top/down assignment of positions of contributing entities respectively. The processor is also configured to periodically release and reassign, by the processor, contributing entities' positions into a next successive higher position in the age ranges tabulation data structure of the relational multi-level tree system during a position assignment reprioritizing process, based on an interval indication or during the contributing entities' age advancement. One or more contributing entities are graduated out of the relational multi-level tree system in the event the one or more contributing entities' age exceeds the defined age range intervals. The processor is further configured to perform fair distributions to the contributing entities based on their age-ordered assigned positions in the relational multi-level tree system.

The detailed description is set forth with reference to the accompanying figures. In the figures, the left-most digit(s) of a reference number identifies the figure in which the reference number first appears. The use of the same reference numbers in different figures indicates similar or identical items.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items.

FIGS. 1a-b show embodiments of age range interval tabulations for a population;

FIG. 2 shows an embodiment of a level strength analysis chart (LSAC);

FIGS. 3a-b illustrate contribution strengths and contribution weights;

FIGS. 4a-b show embodiments of constructing a flat-top multi-level tree and multiple adjacent flat-top multi-level trees;

FIG. 5 shows an embodiment of a structured relational multi-level tree including one or more flat-top multi-level trees within respective level of ARIT;

FIG. 6 shows an embodiment of the flow of graduating entities out of the relational multi-level tree system; and

FIGS. 7a-b show embodiments of according fair distribution to entities in the relational multi-level tree system.

### DETAILED DESCRIPTION

In the following description, for purposes of explanation, specific numbers, materials and configurations are set forth in order to provide a thorough understanding of the present frameworks and methods and in order to meet statutory written description, enablement, and best-mode requirements. However, it will be apparent to one skilled in the art that the present frameworks and methods may be practiced without the specific exemplary details. In other instances, well-known features are omitted or simplified to clarify the description of the exemplary implementations of the present framework and methods, and to thereby better explain the present framework and methods. Furthermore, for ease of understanding, certain method steps are delineated as separate steps; however, these separately delineated steps should not be construed as necessarily order dependent in their performance.

The present disclosure references various representative non-limiting embodiments that are provided for purpose of illustration to aid understanding. In the present disclosure, depiction of a given element or consideration or use of a particular element number in a particular FIG. or a reference thereto in corresponding descriptive material can encompass the same, an equivalent, or an analogous element or element number identified in another FIG. or descriptive material associated therewith. The use of “/” in a FIG. or associated text is understood to mean “and/or” unless otherwise indicated. The use of the term approximately or the recitation of a particular numerical value or value range herein is understood to include or be a recitation of an approximate numerical value or value range, within +/−20%, +/−15%, +/−10%, +/−5%, +/−2.5%, or +/−0% of a stated, measured, baseline, target, or intended value.

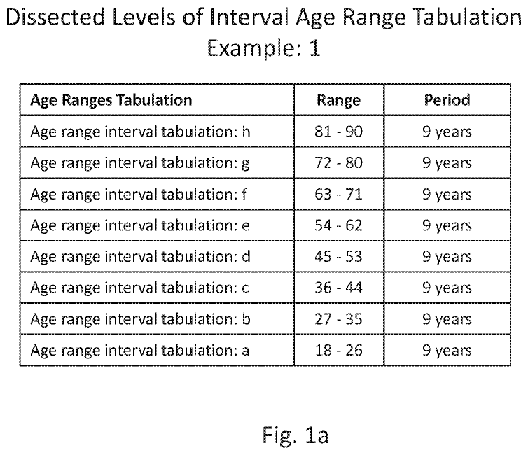

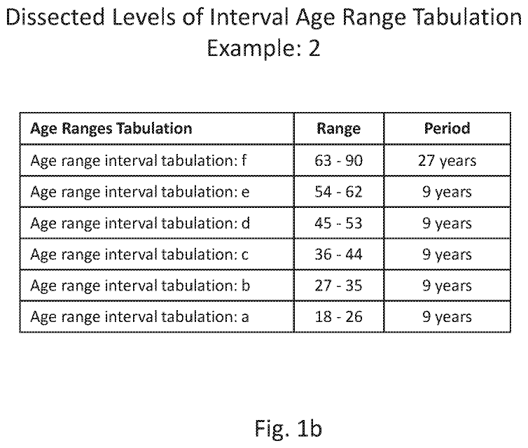

FIGS. 1a-b show embodiments of an age range interval tabulation for a population. The population can be of any size. In one embodiment, the population includes a population of an area, for example, a country. In another embodiment, the population includes the world's population. In one embodiment, the information of the entities in the population is recorded and stored in a database. The information may include the name, age, birthday and contact details of an entity. Other information of the entities may also be useful. In one embodiment, the population is dissected into a plurality of age range intervals according to a defined optimal number of age range intervals. The optimal number of age range intervals may be defined according to the scale and needs of the population or economy. The optimal number of age range intervals may be defined by a processor based at least in part on the age information stored in the database.

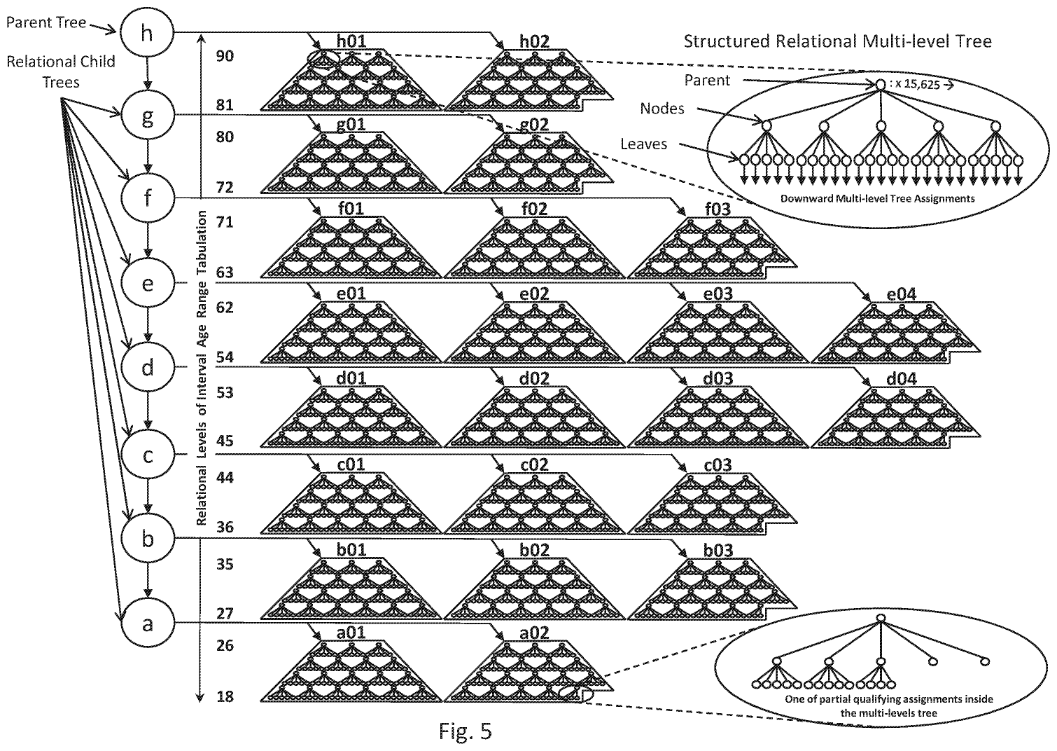

Refer to the exemplary age range interval tabulations (ARITs) shown in FIGS. 1a-b. The population may include a group of people with their ages ranging from 18 years old to 90 years old. The age range intervals may be defined above a threshold age. In this example, the threshold age may be 17 years old. As shown in FIG. 1a, the optimal number of age range intervals may be defined to be 8 with each age range interval being 9 years. Accordingly, the population is dissected into 8 age range intervals from interval a to interval h with each age range interval being 9 years. Other optimal number of age range intervals and the number of years for each age range interval may also be useful. The number of years for each age range interval may be the same or different. For example, as shown in FIG. 1b, the optimal number of age range intervals may be defined to be 6, with each age range interval being 9 years from the interval: a to interval: e and with the age range interval being 27 years for interval: f. In one embodiment, the optimal number of age range intervals corresponds to levels of an age ranges tabulation data structure of a relational multi-level tree system which is shown in FIG. 5.

In one embodiment, prior to constructing the relational multi-level tree system, the entities' positions are sorted, for example, by the processor, based on the age information in the database to form an ordered age priority sequence. For example, the entities' position may be sorted according to the following rules:
a) oldest age first according to birth-date and birth-time, taking into consideration the online system registration-time priority; and/or
b) youngest age first according to birth-date and birth-time, taking into consideration the online system registration-time priority.
   Once the entity's position is assigned, a unique assignment serial number may be tagged onto every entity's position for verification purposes.

If two or more entities having the same birth-date and birth-time are encountered, the earliest system registration-date-time may be used for resolving any assignment priority conflicts. For example, John and Jason both were born at the same time on the same day. However, Jason manages to clock in his registration application at 09:00:54 am, one second before John clocking in at 09:00:55 am on the same day of the opening registration. Jason will be placed in a position prior to John in the ordered age priority sequence after resolving the position assignment priority conflicts.

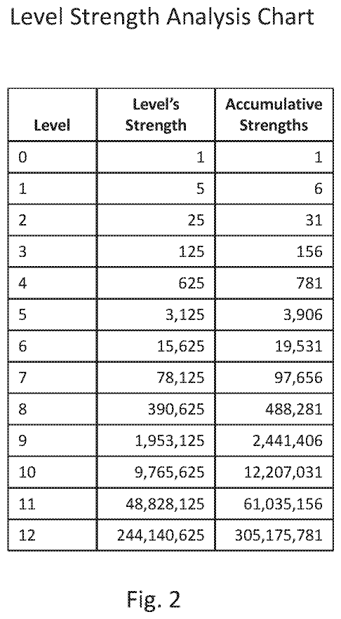

FIG. 2 shows an embodiment of a level strength analysis chart (LSAC). The LSAC may be constructed based on a predetermined contribution strength. In the exemplary LSAC shown in FIG. 2, the contribution strength is predetermined to be 5. Other contribution strengths may also be useful which may result in LSACs with different level strengths and accumulative strengths.

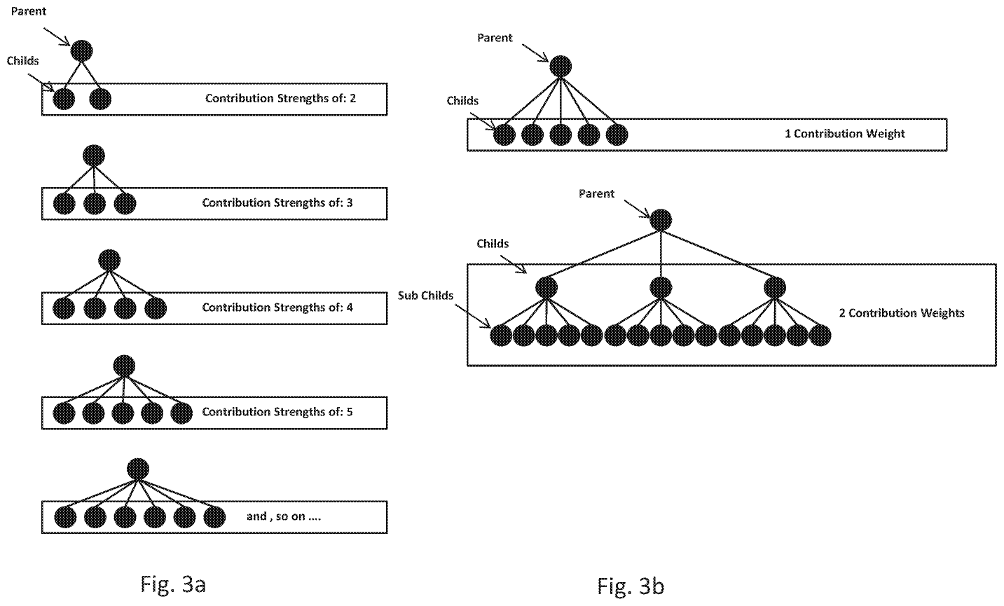

Refer to FIG. 3a in which the contribution strength is illustrated. The contribution strength is the pre-determined number of collective child entities to be assigned to each entity in the multi-level tree system. For example, if the contribution strength of the multi-level tree system is predetermined to be 3, then each active entity in the multi-level trees would be assigned 3 child entities. If the contribution strength of the multi-level tree system is predetermined to be 5, then each active entity in the multi-level trees would be assigned 5 child entities.

Refer to FIG. 3b in which the contribution weight is illustrated. Contribution weights are the levels of child or sub-child entities predetermined to qualify an active qualifying entity for a full fair distribution assignment. If one level of contribution weights is predetermined, then each active qualifying entity could only be computed for a full qualifying fair distribution assignment based on 5 collective strengths of child entity assignments which include only one level of contribution weight. If two levels of contribution weights is predetermined, then each active qualifying entity could be computed for a full qualifying fair distribution assignment based on a total of thirty (30) collective strengths of child and sub-child entity assignments. The assignment may start with the active qualifying entity itself as level: 0, the strengths of 5 collective child entities in the qualifying entity's level: I assignments and 25 collective sub-child entities in the qualifying entity's level: 2 assignments. Therefore, the number of child contributing entities including child and sub-child entities assigned to each entity may be obtained by the equation:

x^{y}+x^{y-1}+x^{y-2}+ . . . +x¹,

wherein x is the strength of a contributing entity and y is the contribution weight.

Referring back to FIG. 2, the exemplary LSAC shown is constructed based on contribution strengths of 5. The LSAC may have two important functions in constructing a multi-level tree:
a) it may be used to guide and limit the desired optimal sizes of structured multi-level tree to be constructed and to preventing them from getting overly large; and
b) it may be used for measuring and determining the numbers of adjacent multi-level trees needed for the total number of entities to be positioned inside respective levels of ARIT.

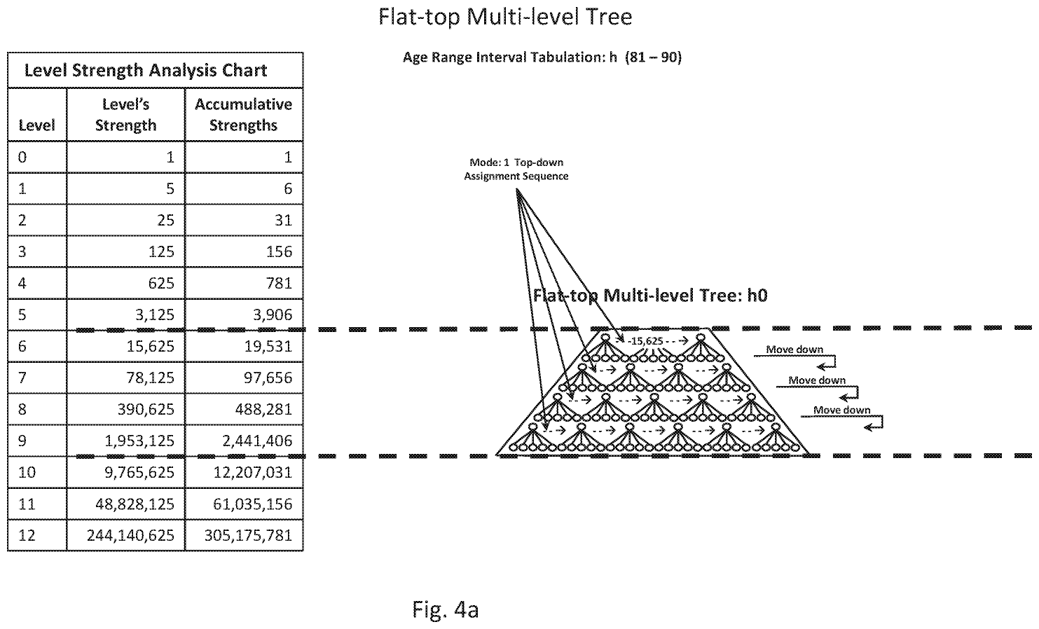

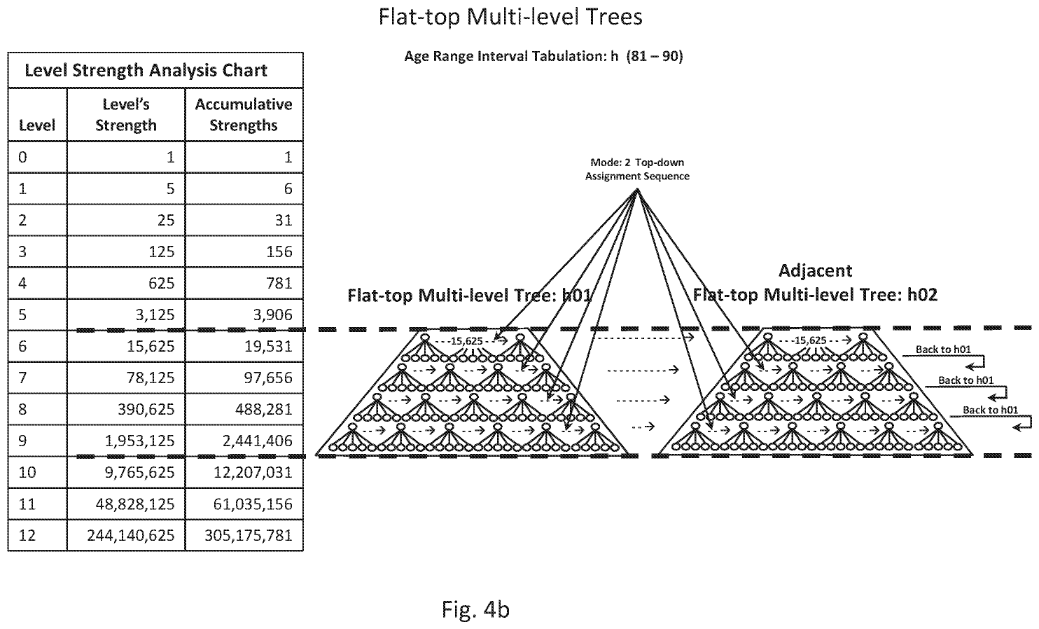

FIG. 4a shows an embodiment of constructing a flat-top multi-level tree. When constructing the multi-level tree, instead of starting with one parent at the top of conventional multi-level trees which may result in endlessly broadening base effects, a flat-top multi-level tree may be constructed. In one embodiment, a flat-top multi-level tree is constructed by determining the desired level: 0 of the multi-level tree itself. For example, a flat-top multi-level tree for the ARIT: h may be constructed by starting with the assignment of 15,625 prioritized entities as level: 0 by selecting level: 6 of the LSAC in FIG. 2. Since the level strength of 15,625 in level: 6 of the LSAC is selected to be the desired level: 0 of the flat-top multi-level tree, this would result in minority accumulative strengths of 3,906 from level: 0 to level: 5 shown in the LSAC being effectively channeled to become the base support of the flat-top multi-level tree itself. This enables more positions at the base of the flat-top multi-level tree to assign child entities while maintaining the stableness of the structure as compared to a conventional multi-level tree system.

In one embodiment, the flat-top multi-level tree is further constructed by assigning the prioritized entities into different positions in the multi-level tree. In one embodiment, the contribution strength and contribution weight are predetermined. For example, contribution strengths of 5 and 2 levels of contribution weights may be predetermined, and the desired optimal level: 0 strength of 15,625 taken from level: 6 of the LSAC may be selected to be the desired level: 0 of the age range interval tabulation: h.

Starting with the first position prioritized entity within the ARIT, sequentially assign 15,625 position prioritized entities as level: 0 into the ARIT: h in a top-down assignment pattern. Next, assign entities to level: 1 of the multi-level tree by assigning each assigned entity in level: 0 with 5 child position prioritized entities. After assigning all level: 0 entities with 5 child entities in level: 1, move down to level: 2 of the multi-level tree to assign each level: 1 entity with 5 child entities.

The top-down assignment pattern may subsequently move down to assign every level of assigned entities with 5 child entities each. These assignment sequences may be performed until all position prioritized entities within the ARIT: h are all assigned with a due position in the flat-top multi-level tree. Depending on the available prioritized entities within respective ARIT, each entity may be assigned with two full levels of child and sub-child entities, or with partially assigned level: 2 of the multi-level tree. The top-down assignment pattern may then move down to process the next dissected level of ARIT. For instance, ARIT: g may then be processed, followed by ARIT: f, ARIT: e, ARIT: d, ARIT: c, ARIT: b and ARIT: a in a downward manner.

There may be one or more multi-level trees within one dissected level of ARIT. In one embodiment, depending on the total number of entities to be positioned inside the respective ARIT level, these entities can be grouped into a plurality of structured adjacent multi-level trees within respective ARIT level as shown in FIG. 4b. For example, compute the number of entities to be positioned in one of the plurality of adjacent multi-level trees by dividing the total number of entities to be positioned inside an ARIT level by the difference between the accumulative strengths of two levels in the LSAC. For example, the size of accumulative strengths 2,441,406 is selected from: Level: 6 to Level: 9 of the LSAC. In this case, the structurally limiting size of one flat-top multi-level tree to be created may include 2,437,500 entities. This is computed by subtracting 2,441,406 by 3,906 accumulative strength in Level: 6 of the LSAC. If the total number of entities to be positioned within the ARIT: h is 4,875,180, the number of adjacent flat-top multi-level trees required to position all the entities in the ARIT level would be 2, which is obtained by dividing 4,875,180, the total number of entities by 2,437,500, the number of entities within one multi-level tree. Therefore, the adjacent flat-top multi-level trees: h01 and h02 may be obtained.

FIG. 5 shows an embodiment of a structured relational multi-level tree including one or more flat-top multi-level trees within respective level of the ARIT. As discussed in FIGS. 4a-b, there may be different modes of applying top-down assignment pattern when constructing the flat-top multi-level trees. Mode 1 may apply the top-down assignment pattern for only one single flat-top multi-level tree needed in the respective ARIT level. Mode 2 may apply the top-down assignment pattern for a plurality of adjacent flat-top multi-level trees needed in the respective ARIT level. Alternative modes of top-down assignment pattern may also be applied for the respective ARIT level when required.

In one embodiment, the assignment of entities within an ARIT level is done by Mode 1 which results in only one flat-top multi-level tree in the ARIT level. For example, the top-down assignment may first assign 15,625 prioritized entities in the direction of left to right as the level: 0 of a flat-top multi-level tree. The assignment then moves down to the level: 1 to assign 5 child entities to the first assigned level: 0 entity. The assignment moves on to similarly assign 5 child entities to the second assigned level: 0 entity and the third assigned level: 0 entity and the subsequent assigned level: 0 entities, until the last assigned level: 0 entity of the 15,625 entities is reached. The top-down assignment may then move down to level: 2 to assign 5 child entities to each assigned level: 1 entity until the last assigned entity in level: 1 is reached. The top-down assignment may continue to assign 5 child entities to every entity positioned in the previous level in a similar manner downwards until the last prioritized entity is assigned a position in the multi-level tree in the ARIT level.

In another embodiment, the assignment of entities within an ARIT level is done by Mode 2 which results in a plurality of adjacent flat-top multi-level trees in the ARIT level. For example, the ARIT: h may have a large quantity of entities to be assigned a position. With the help of the LSAC, it may be computed that the number of adjacent flat-top multi-level trees required to position all the entities in the particular ARIT: h is 2. Other number of adjacent flat-top multi-level trees in a particular ARIT level may also be possible, depending on the total number of entities to be assigned in the particular ARIT level and the level strength desired. The top-down assignment may first assign 15,625 prioritized entities in the direction of left to right as the level: 0 in a flat-top multi-level tree. The assignment then may moves across to assign another 15,625 prioritized entities in the direction of left to right as the level: 0 in the adjacent flat-top multi-level tree: h02. The assignment then moves back to the flat-top multi-level tree: h01 and moves down to the level: 1 to assign 5 child entities to the first assigned level: 0 entity. The assignment moves on to similarly assign 5 child entities to the second assigned level: 0 entity and the third assigned level: 0 entity and so on, until the last assigned top multi-level tree: h01 level: 0 entity is reached. The top-down assignment sequence may then move over to the adjacent flat-top multi-level tree: h02 to apply the similar assignment sequence, until the last assigned adjacent flat-top multi-level tree: h02 level: 0 entity is reached.

The top-down assignment may then move back to the flat-top multi-level tree: h01 and move down to level: 2, whereby 5 child entities are assigned at level: 2 to each of the assigned level: 1 entities.

The top-down assignment may continue moving to and fro between the flat-top multi-level trees h01 and h02 to assign 5 child entities for every entity assigned in the similar manner described above. The top-down assignment is carried out downwards in the multi-level trees until the last positioned prioritized entity in the ARIT level is assigned a position in the multi-levels trees.

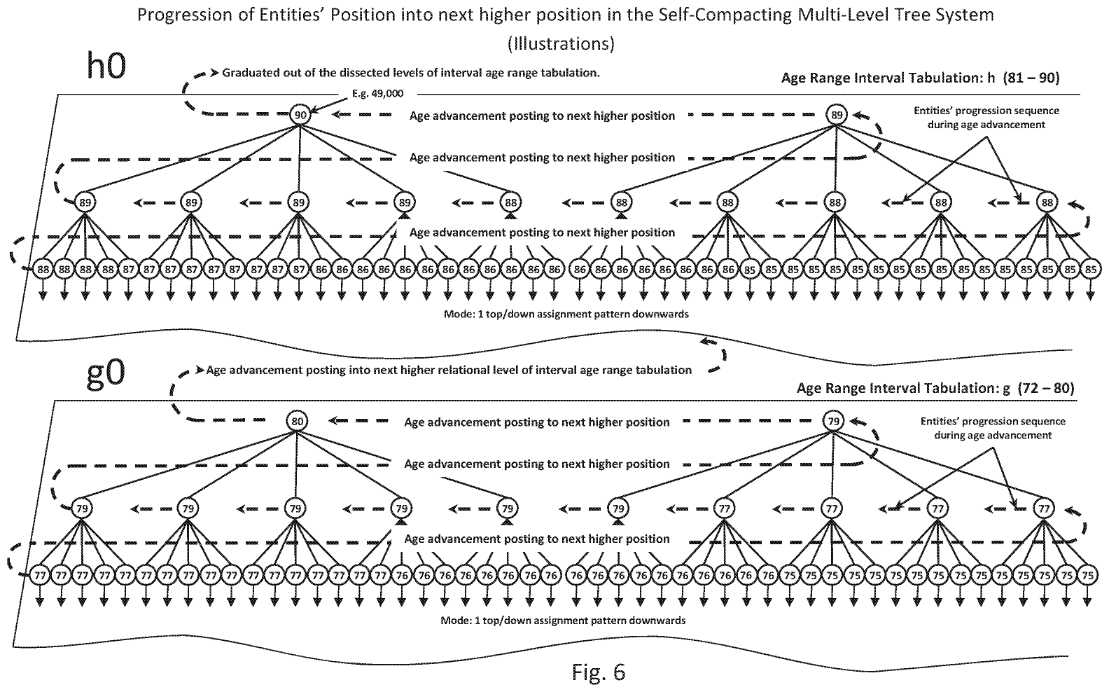

FIG. 6 shows an embodiment of the progression of entities' positions into the next higher positions in the multi-level tree system during the subsequent entities' age advancement. In one embodiment, in order to enable the entities assigned at the base of the respective flat-top multi-level trees to gradually resume qualifying positions, the position assignment reprioritizing process is applied for each entity during the subsequent entities' age advancement. Younger entities may be released from their assigned positions to take over those qualifying positions, previously held by older entities. In one embodiment, this is done by the position assignment prioritizing process based on an interval indication or during subsequent entities' age advancement, whereby the process performs the reprioritization of the entities' positions into a new prioritized position sequence.

As every entity's age advances, the position assignment reprioritizing process may automatically identify all the oldest entities at the top levels of the respective ARITs to be those posted into the bases of successive parent ARIT level. For example, all entities with age 80 in the ARIT: g may be posted into the base of the parent ARIT: h when they reach 81) years old. These may similarly be applied to other ARIT levels.

In one embodiment, when all the oldest entities in the top level of the respective ARIT are posted upwards into the bases of the respective parent ARIT during entities' age advancement, those entities who are the second oldest within the ARIT level are moved upward to be assigned a new position at the top of the ARIT level. For example, all entities with age 79 in the ARIT: g may be moved upward to be assigned a new position at the top of the ARIT: g. These may similarly be applied to every ARIT during the reprioritizing process.

In one embodiment, the position assignment reprioritizing process is performed periodically to re-assign every entity in the relational multi-levels tree system into a new position, to subsequently release every entity from his/her contributing position, and to resume respective scheduled qualifying positions based on age priorities.

FIG. 6 also shows an embodiment of graduating entities out of the relational multi-level tree system. In order for the relational multi-levels tree system to take in new entities, those oldest age entities who have qualified due scheduled years of fair distribution assignments may be graduated from the relational multi-level tree system, so that all other scheduled prioritized entities could go through similar schedules of fair distribution assignments. The process of graduating entities out of the relational multi-level tree system may also be periodically done by the position assignment reprioritizing process based on interval indication or during subsequent entities' age advancement, whereby the process performs the reprioritization of the entities' positions for progressions.

In one embodiment, the position assignment reprioritizing process includes active entities and excludes entities whose ages exceed the age ranges of the dissected levels of ARIT. For example, all oldest entities at the top of the ARIT: h, for example, 90 years old, may be completely graduated from the relational multi-levels tree systems at the final year of the entity's age advancement. These self-compacting processes performed annually enable the relational multi-levels tree to become self-sustainable.

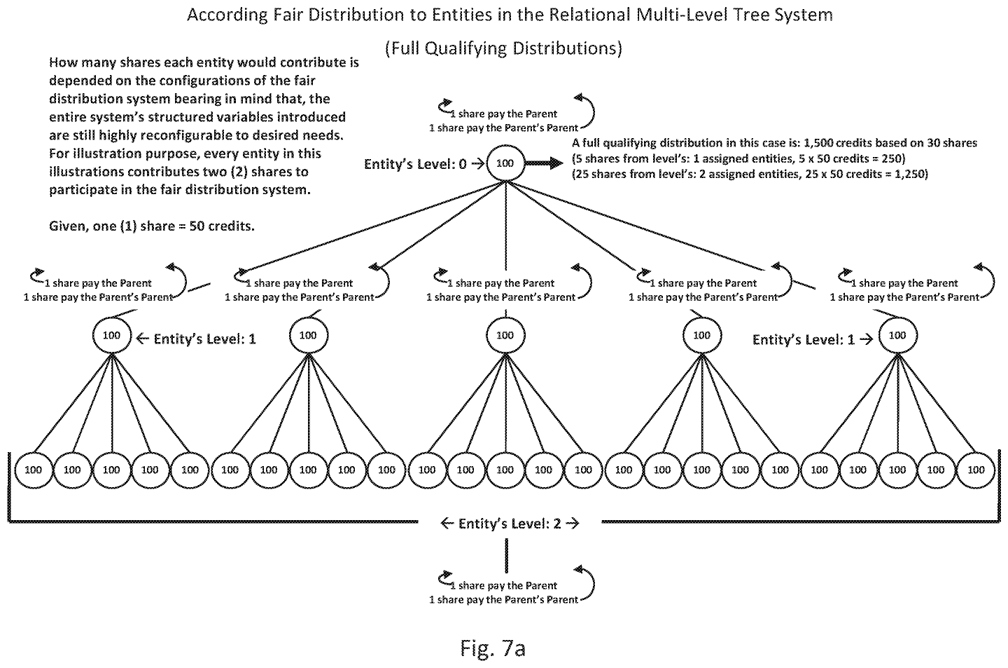

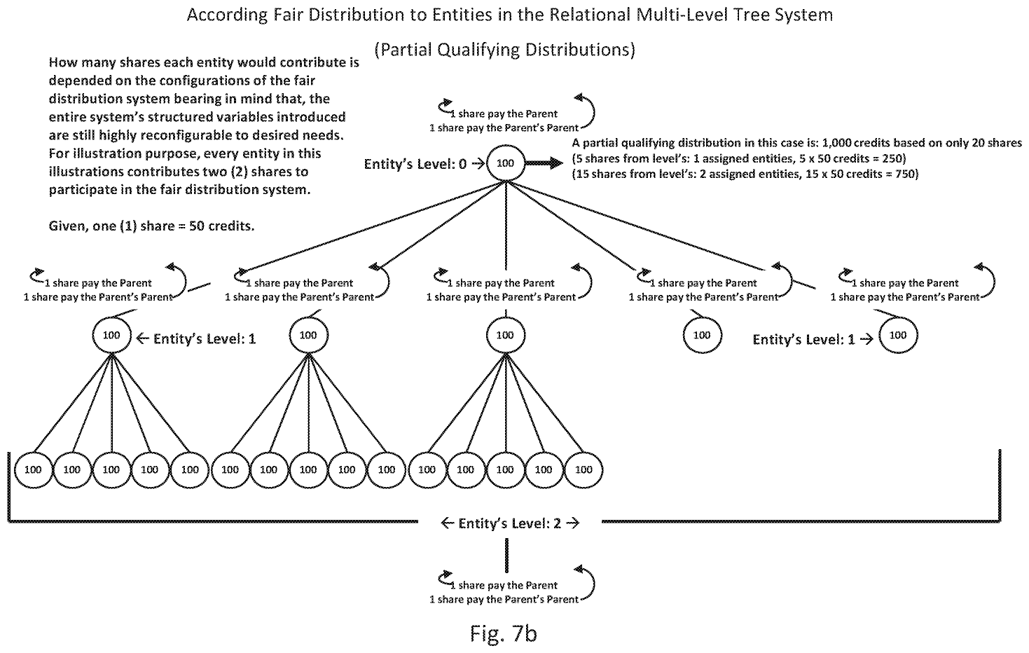

FIG. 7a shows an embodiment of according fair distribution to entities in the relational multi-level tree system. The number of shares each entity would contribute may depend on the configurations of the fair distribution system. The distribution system may be designed in such a way that the structured variables introduced are highly reconfigurable to desired needs.

In one embodiment, every entity in the relational multi-level tree system contributes a predetermined numbers of shares to participate in the fair distribution system. The number of shares each entity contributes may depend on the number of levels upwards that the entity may support in order to achieve fair distribution. In one embodiment, each share is used to pay the qualifying parent entity in the levels upwards. For example, every entity in the relational multi-levels tree system contributes two (2) shares to participate in the fair distribution system. For example, one share may be equivalent to a predetermined number of credits, for example, 50 credits, then the total of two shares would be 100 credits. In one embodiment, one share may be used to pay the parent entity, another share may be used to pay the parent entity's parent entity. This may be applicable when the contribution weight is 2.

In one embodiment, a fully assigned qualifying distribution is accorded as shown FIG. 7a. For example, the fully assigned qualifying distribution may receive:
5 shares from level: 1 assigned entities, 5×50 credits=250
25 shares from level: 2 assigned entities, 25×50 credits=1,250
   Therefore, the fully assigned qualifying distribution for an entity is: 30 shares, equivalent to 250+1250=1,500 credits.

In another embodiment, a partially assigned qualifying distribution is accorded as shown in FIG. 7b. For example, some child entity/entities may be only partially assigned with fewer than 5 sub-child entities or not assigned with any sub-child entities. In the example shown in FIG. 7b, the partially assigned qualifying distribution may receive:
5 shares from level: 1 assigned entities, 5×50 credits=250
only 15 shares from levels: 2 assigned entities, 15×50 credits=750
   Therefore, the partially assigned qualifying distribution for a partially assigned entity is: 20 shares, equivalent to 250+750=1,000 credits.

The following provides an overview of one embodiment for creating a self-compacting and self-sustainable multi-level tree system for according fair distributions.
a) Dissect and tabulate the desired ARIT for scheduling fair distributions at different age intervals of the relational multi-level tree system;
b) pre-sort entities' position assignment sequences based on age-ordered priorities desired;
c) construct a LSAC needed based on the contribution strengths desired for the relational multi-level tree system;
d) select the desired level: 0 strength and the accumulative strength parameter from the LSAC to create the desired size limiting flat-top multi-level trees in the relational multi-level tree system;
e) measure, compare and compute the total number of entities to be assigned within the ARIT using the LSAC to select the desired sizes in order to construct one multi-level tree or a plurality of adjacent flat-top multi-level trees needed within the ARIT level;
f) apply mode: 1 or mode: 2 top-down position assignment pattern when appropriate, whereby assigning entities into one flat-top multi-level tree or a plurality of adjacent flat-top multi-level trees within respective ARIT level;
g) periodically perform position assignment reprioritizing process to re-schedule fair distribution assignment to advance each entity into the next successive higher position, during subsequent entities' age advancements; and
h) subsequently graduate entities out of each ARIT level, whereby entities' ages exceed each level of ARIT in the age ranges tabulation data structure.

The embodiments disclosed herein overcome the problems of a traditional tree with an open ended base which increases exponentially by providing structured multi-level trees in the age ranges tabulation data structure of the relational multi-level tree system. The construction of the multi-level trees and assigning of entities' positions in the tree are based on optimal size and measurement considerations made in accordance with a LSAC which includes level strength and level accumulative strength parameters. Unlike traditional trees where assignment of entities in a tree is performed such that the levels in the tree grow exponentially larger towards the base and the size of the tree grows indefinitely with an endless base in cases involving large quantities of entities, the present embodiments require a specific number of interval levels in the relational multi-level tree system which is based on the age range intervals of the entities, and that further assignment of entities' positions in their respective age range interval is based on optimal size and measurement considerations of one multi-level tree or a plurality of adjacent multi-level trees which are made in accordance with the level strength accumulative parameter of the LSAC. The LSAC is applied to determine and construct an optimal size and number of multi-level trees within an age range interval depending on a total number of contributing entities to be positioned in that age range interval. A single multi-level tree or multiple adjacent multi-level trees are constructed based on the optimal size and measurement considerations made in accordance with the optimal level strength accumulative parameter of the LSAC. The assignment of contributing entities into the adjacent multi-level trees in the age range interval which is performed using the LSAC ensures that each multi-level tree of the adjacent multi-level trees is constructed with a limited size and prevents assignment of entities in the tree which results in a tree that grows indefinitely with an endless base. On the other hand, conventional techniques do not apply any LSAC having the level strength and level accumulative strength parameters considerations in assigning entities into adjacent multi-level trees within a relational multi-level tree system and its respective age range interval.

The disclosure herein enables a systematic positioning of entities in an improved and structured relational multi-level tree system. This advantageously allows efficient and fair distributions in a self-compacting and self-sustainable multi-level tree system. The structured assignment of entities in the relational multi-level tree system is realised by applying assignment in multi-level trees in the age ranges tabulation data structure of the relational multi-level tree system and based on optimal size and measurement considerations of the one or more multi-level trees made in accordance with the LSAC, instead of random assignments in traditional trees which are not based on the LSAC.

The present disclosure further requires periodically releasing and reassigning contributing entities' positions into a next successive higher age range interval in the age ranges tabulation data structure of the relational multi-level tree system could be based on interval indications or during the contributing entities' age advancement, wherein one or more contributing entities' are graduated out of the relational multi-level tree system in the event the one or more contributing entities' age exceed the defined age range intervals. This allows for progression of entities into a next higher level in the multi-level tree system and obviates entities from indefinitely being assigned into a fixed position in the multi-level tree system.

In one embodiment, the relational multi-level tree system entails with it certain fair distribution policies. Some examples of such policies are shown below:
a) All entities participating in the fair distribution system must be minimum 18 years old and above.
b) Each entity may not pay any registration fee to remain as an active or non-active account holder.
c) Each entity, regardless of qualifying years, shall subscribe to respective contribution before each fair distribution year begins, in order to become an active entity account status holder.
d) Each entity shall pay the year's monthly administrative fee together with the year's subscription in advance, in order to become an active entity account status holder.
e) Each entity shall pay any local tax required by the local authority in advance, in order to become an active entity account status holder.
f) Only active entity account status holders would be managed and included into the following year position assignment reprioritizing process, during entities' age advancements.
g) Only active entity account status holders could donate, will or entrust, his or her account managements and maintenances to designated spouse or estate.
h) Each active entity account status holder successfully assigned with full qualifying child and sub-child distribution assignments would receive the due year-long monthly fair distribution benefits, computed according to the number of qualifying child and sub-child entities assignments.
i) Each active entity account status holder including those partially assigned with child and sub-child entities assignments would also receive the due yearlong monthly partially qualifying fair distribution benefits, computed according to the number of qualifying child and sub-child entities assignments.
j) Each active entity account status holder successfully assigned with fully qualifying child and sub-child leveraging assignments shall agree to donate a token of the monthly qualifying benefits toward contributing Head Start Young Generation (HSYG)'s objective, in the spirit of the benefited old empowering back the young generations for their congregating roles in supporting economy rejuvenations.
k) Each active entity account status holder does not require sponsoring any child or sub-child entities.
l) Each active entity account status holder does not consume and does not market any products of any kind.
m) Each active entity account status holder is not an IBO (Independent Business Owner).
n) Each active entity account status holder does not qualify fair distribution benefits based on commission schemes.
o) Entities are free to lapse or reinstate respective account status before each distribution year begins.
p) Entities lapse any particular year's participation regardless of anticipating a qualifying or non-qualifying period would automatically become inactive account status holder.
q) All inactive account status holders would not be managed but automatically excluded from the following year position assignment reprioritizing process.
r) Any inactive account status holder cannot donate, will or entrust, his or her account managements and maintenances to designated spouse or the estate, otherwise the account is successfully reinstated into active status.
s) Entities are free to reinstate an inactive account status before the following distribution year begins by contributing the respective year's subscription, fee and tax required in advance, in order to become an active entity account status holder.
t) Each entity is aware that in the event of reinstating an inactive account status, these accounts reinstating would incur insertion of entity into the position assignment reprioritizing process, whereby, these age prioritized insertions would result in insertion displacements of other active entity account status holders' positions within the collective fair distribution system.
u) In order to be fair to all faithful entities and to discourage individuals anticipating respective non-qualifying period or exploiting unfair practices through irregular participations in the collective fair distribution system, a reinstated active entity account status holder is required to observe a minimum of ‘n’ number of years of insertion transfers for every one (1) year intentional or non-intentional lapse participation, this is done by transferring any assigned qualifying benefits to the first or subsequent partially qualifying entity at the lowest level of respective ARIT, whom are affected by these insertion displacements.
v) Each entity is aware that new citizenship conversion would also incur insertion of the entity into the position assignment reprioritizing process, whereby such age prioritized insertions would result in insertion displacements of others active entity account status holders' positions within the collective fair distribution system. Therefore, inserted active entity account status holder of the newly converted citizen is required to observe one (1) year of insertion transfer, this is done by transferring any assigned qualifying benefits to the first or subsequent partially qualifying entity at the lowest level of respective ARIT, whom are affected by these insertion displacements.
w) Each entity successfully assigned the number of child and sub-child entities during the year's position assignment reprioritizing process would be given a fair distribution assignment certificate at the beginning of the fair distribution year. Following are samples of fair distribution certificates to be issued for proof of assignment results:

(SAMPLE)
Certificate of Fair Distribution Assignment 2023
Full Assignment
Contributor Account No: 030-7645-8993213
Contributor Name: John
Contact: email address
Fair Distribution Year: 2023
Account Status: “Reinstated”/“Active”
Position Serial Code: 13-D02B-488280
Position Code: 13-D02B-L08-390625
Parent: D02B-L07-387654
Parent Serial Code: 13-D02B-487232
Qualifying Status: “Full”/“Partial”/“Insertion
Transfer”/“None”
Insertion Transfer Received: “Yes”/“No”
Numbers of Child/Sub-Child Assignments: 30
Monthly Qualifying Fair Distributions: $1,500.00
Month's Donation to HSYG Objective: $100.00
Month's Net Fair Distributions Receive: $1,400.00
Assignment Details

| | | Position Code | Position | |
|---|---|---|---|---|
| | | (YY-DIV- | Serial | |
| | | Level- | (YY-DIV- | |
| Relation | Name | ######) | ######) | Contact |
| Child | Michael | 13-D02B- | 13-D02B- | e-mail |
| | | L09-408621 | 489321 | |
| Sub- | William | 13-D02B- | 13-D02B- | e-mail |
| Child | | L10-507621 | 491891 | |
| Sub- | Annie | 13-D02B- | 13-D02B- | e-mail |
| Child | | L10-507622 | 491892 | |
| Sub- | Ruth | 13-D02B- | 13-D02B- | e-mail |
| Child | | L10-507623 | 491893 | |
| Sub- | Joyce | 13-D02B- | 13-D02B- | e-mail |
| Child | | L10-507624 | 491894 | |
| Sub- | Vivian | 13-D02B- | 13-D02B- | e-mail |
| Child | | L10-507625 | 491895 | |
| Child | Lucy | 13-D02B- | 13-D02B- | e-mail |
| | | L09-408622 | 489322 | |
| Sub- | Roger | 13-D02B- | 13-D02B- | — |
| Child | | L10-507626 | 491896 | |
| Sub- | Luke | 13-D02B- | 13-D02B- | e-mail |
| Child | | L10-507627 | 491897 | |
| Sub- | Edward | 13-D02B- | 13-D02B- | e-mail |
| Child | | L10-507628 | 491898 | |
| Sub- | Kenny | 13-D02B- | 13-D02B- | — |
| Child | | L10-507629 | 491899 | |
| Sub- | Kris | 13-D02B- | 13-D02B- | e-mail |
| Child | | L10-507630 | 491900 | |
| Child | Katherine | 13-D02B- | 13-D02B- | e-mail |
| | | L09-408623 | 489323 | |
| Sub- | Mark | 13-D02B- | 13-D02B- | e-mail |
| Child | | L10-507631 | 491901 | |
| Sub- | Jane | 13-D02B- | 13-D02B- | — |
| Child | | L10-507632 | 491902 | |
| Sub- | Keith | 13-D02B- | 13-D02B- | e-mail |
| Child | | L10-507633 | 491903 | |
| Sub- | Nancy | 13-D02B- | 13-D02B- | e-mail |
| Child | | L10-507634 | 491904 | |
| Sub- | May | 13-D02B- | 13-D02B- | e-mail |
| Child | | L10-507635 | 491905 | |
| Child | Edwin | 13-D02B- | 13-D02B- | — |
| | | L09-408624 | 489324 | |
| Sub- | Louis | 13-D02B- | 13-D02B- | e-mail |
| Child | | L10-507636 | 491906 | |
| Sub- | Bill | 13-D02B- | 13-D02B- | e-mail |
| Child | | L10-507637 | 491907 | |
| Sub- | Gilbert | 13-D02B- | 13-D02B- | — |
| Child | | L10-507638 | 491908 | |
| Sub- | James | 13-D02B- | 13-D02B- | e-mail |
| Child | | L10-507639 | 491909 | |
| Sub- | Tommy | 13-D02B- | 13-D02B- | e-mail |
| Child | | L10-507640 | 491910 | |
| Child | Jonathon | 13-D02B- | 13-D02B- | e-mail |
| | | L09-408625 | 489325 | |
| Sub- | Tony | 13-D02B- | 13-D02B- | e-mail |
| Child | | L10-507641 | 491911 | |
| Sub- | Charles | 13-D02B- | 13-D02B- | — |
| Child | | L10-507642 | 491912 | |
| Sub- | Torn | 13-D02B- | 13-D02B- | e-mail |
| Child | | L10-507643 | 491913 | |
| Sub- | Billy | 13-D02B- | 13-D02B- | e-mail |
| Child | | L10-507644 | 491914 | |
| Sub- | Lisa | 13-D02B- | 13-D02B- | e-mail |
| Child | | L10-507645 | 491915 | |

(SAMPLE)
Certificate of Fair Distribution Assignment 2023
Partial Assignment
Contributor Account No: 030-7645-8993378
Contributor Name: Jack
Contact: email address
Fair Distribution Year: 2023
Account Status: “Reinstated”/“Active”
Position Serial Code: 13-D02B-488281
Position Code: 13-D02B-L08-390626
Parent: D02B-L07-386352
Parent Serial Code: 13-D02B-486732
Qualifying Status: “Full”/“Partial”/“Insertion
Transfer”/“None”
Insertion Transfer Received: “Yes”/“No”
Numbers of Child/Sub-Child Assignments: 24
Monthly Qualifying Fair Distributions: $1,200.00
Month's Donation to HSYG Objective: $0.00
Month's Net Fair Distributions Receive: $1,200.00
Assignment Details

| | | Position | | |
|---|---|---|---|---|
| | | Code | Position | |
| | | (YY-DIV- | Serial | |
| | | Level- | (YY-DIV- | |
| Relation | Name | ######) | ######) | Contact |
| Child | Gilbert | 13-D02B- | 13-D02B- | e-mail |
| | | L09-408921 | 489321 | |
| Sub- | Billy | 13-D02B- | 13-D02B- | e-mail |
| Child | | 508621 | 491891 | |
| Sub- | Eileen | 13-D02B- | 13-D02B- | e-mail |
| Child | | 508622 | 491892 | |
| Sub- | Alan | 13-D02B- | 13-D02B- | e-mail |
| Child | | L10-508623 | 491893 | |
| Sub- | Kelvin | 13-D02B- | 13-D02B- | e-mail |
| Child | | L10-508624 | 491894 | |
| Sub- | Johnny | 13-D02B- | 13-D02B- | e-mail |
| Child | | 508625 | 491895 | |
| Child | Willie | 13-D02B- | 13-D02B- | e-mail |
| | | L09-408922 | 489322 | |
| Sub- | Oliver | 13-D02B- | 13-D02B- | — |
| Child | | L10-508626 | 491896 | |
| Sub- | Alton | 13-D02B- | 13-D02B- | e-mail |
| Child | | L10-508627 | 491897 | |
| Sub- | Lily | 13-D02B- | 13-D02B- | e-mail |
| Child | | L10-508628 | 491898 | |
| Sub- | Marry | 13-D02B- | 13-D02B- | — |
| Child | | 508629 | 491899 | |
| Sub- | Paul | 13-D02B- | 13-D02B- | e-mail |
| Child | | L10-508630 | 491900 | |
| Child | Evelyn | 13-D02B- | 13-D02B- | e-mail |
| | | L09-408923 | 489323 | |
| Sub- | Jason | 13-D02B- | 13-D02B- | e-mail |
| Child | | L10-508631 | 491901 | |
| Sub- | Christine | 13-D02B- | 13-D02B- | — |
| Child | | L10-508632 | 491902 | |
| Sub- | Kristine | 13-D02B- | 13-D02B- | e-mail |
| Child | | L10-508633 | 491903 | |
| Sub- | Harry | 13-D02B- | 13-D02B- | e-mail |
| Child | | L10-508634 | 491904 | |
| Sub- | Bobby | 13-D02B- | 13-D02B- | e-mail |
| Child | | L10-508635 | 491905 | |
| Child | Jin | 13-D02B- | 13-D02B- | — |
| | | L09-408924 | 489324 | |
| Sub- | Vanessa | 13-D02B- | 13-D02B- | e-mail |
| Child | | L10-508636 | 491906 | |
| Sub- | Mike | 13-D02B- | 13-D02B- | e-mail |
| Child | | 508637 | 491907 | |
| Sub- | Kenny | 13-D02B- | 13-D02B- | — |
| Child | | L10-508638 | 491908 | |
| Sub- | Wilson | 13-D02B- | 13-D02B- | e-mail |
| Child | | L10-508639 | 491909 | |
| Child | Mindy | 13-D02B- | 13-D02B- | e-mail |
| | | L09-408925 | 489325 | |

(SAMPLE)
Certificate of Fair Distribution Assignment 2023
None Assignment
Contributor Account No: 030-7645-8993675
Contributor Name: Benny
Contact: email address
Fair Distribution Year: 2023
Account Status: “Reinstated”/“Active”
Position Serial Code: 13-D02B-488384
Position Code: 13-D02B-L08-390987
Parent: D02B-L07-386225
Parent Serial Code: 13-D02B-434738
Qualifying Status: “Full”/“Partial”/“Insertion
Transfer”/“None”
Insertion Transfer Received: “Yes”/“No”
Numbers of Child/Sub-Child Assignments: 0
Monthly Qualifying Fair Distributions: $0.00
Month's Donation to HSYG Objective: $0.00
Month's Net Fair Distributions Receive: $0.00
Assignment Details

| | | | | |
|---|---|---|---|---|
| Relation | Name | Position Code | Position Serial | Contact |
| | | (YY-DIV-Level- | (YY-DIV- | |
| | | ######) | ######) | |

Given that young generations of entities in fair distribution societies may start participating in income-leveraging activities at the age of 18, many may be assigned at the base of the multi-level tree system. It may not be so soon for these young generations of entities to immediately qualify for respective scheduled fair distribution benefits as compared to the older contributing entities due to the oldest age order priority rules.

In one embodiment, HSYG is a second tier young generation fair distribution system, in addition to the first tier fair distribution system solution discussed above. In one embodiment, HSYG gives the young generations of entities a head-start in the income-empowerment at the early stage of their life journeys, especially for the young entities or to-be-family-makers to empower themselves when they join the economy. The initial qualifying opportunities for the young and energetic entities in societies may start when they are, for example, in the range of 18 years old to a specified age of 30 years old. Other age ranges may also be useful. It may help serve as an intermediate form of income-empowerment stream on top of individuals' initial excel income capacities derived from contributing to the economy.

In one embodiment, HSYG is fueled by tokens subscription donations derived from the fair distribution contributing entities qualifying respective full fair distribution benefits who agree to contribute a fraction of respective qualifying benefits towards realizing HSYG objectives. Instead of assigning HSYG members by the oldest age order priorities, HSYG multi-level tree systems may start with a youngest age assignment order, for example, from 18 to 30 year-old. Other age ranges may also be useful. Instead of qualifying HSYG members' fair distribution benefits by oldest age order priorities, HSYG fair distribution system qualifies HSYG members by youngest age order priorities.

It is expected that many ageing economies with mushroom' shape populations would gradually be hitting a population ageing rate above 4.2, the average of the OECD member countries. The HSYG fair distribution solution is critical at this point, and it would likely work with more qualifying elderlies donating economically toward supporting shrinking younger populations shouldering reproductive roles in the economies.

Much wealth derived from division of labor activities were further self-centeredly saved away into the individuals' micro saving accounts without having much of them leveraged before being spent off along with inflations. In addition, as much as 40%/o of the Global wealth has been stocked away into the wealth of the private reserves in capitalisms of the twentieth century. The present disclosure has provided a novel Pareto efficient fair distribution solution for the first time by embodying in it many logical, moral and productive ways, including enabling HSYG objectives through a backward re-empowerment chain effects solution for the young and energetic entities to shoulder reproductive roles in the economies. Besides, advocating the use of a LSAC for limiting the size of multi-level trees and preventing them from getting overly large for the first time, the disclosure of progressing entities' positions into the next subsequent higher levels of progressions in the multi-level trees has never been heard of before and never been a practice in any conventional multi-level trees. Without these unique features, no rostering of fair distribution is possible for any multi-level tree systems. The present embodiments aim to deliver a distinctively safe wealth circulation activity in the economy in order to achieve a higher degree of collective generosity and inclusive societies for the 21st century economies.

What is claimed is:

1. A structured method for forming a relational multi-level tree system and progressing entities' positions in the relational multi-level tree system into positions in a next successive higher level in the relational multi-level tree system for effecting fair distributions to the entities, comprising:
providing entity information of contributing entities from a database, wherein the entity information includes age information of the contributing entities and other information that is useful to schedule fair distributions;
defining, by a processor, age range interval tabulations (ARIT) above a threshold age, and an optimal number of ARITs corresponding to levels of an age ranges tabulation data structure of the relational multi-level tree system, wherein the relational multi-level tree system comprises flat-top or adjacent flat-top multi-level trees within respective ARITs of the age ranges tabulation data structure;
determining, by the processor, a number of positions for assigning the contributing entities into respective levels of the ARIT in the age ranges tabulation data structure, wherein:
the age ranges tabulation data structure comprising x levels of ARIT based on the age ranges of contributing entities, wherein
l is the lowest level of the ARIT of the relational multi-level tree system and corresponds to the lowest ARIT of the relational multi-level tree system,
x is the highest level of the ARIT of the relational multi-level tree system and corresponds to the highest ARIT of the relational multi-level tree system, and
level i+1 is a next higher level than an ith level, where i is from 1 to x
−1, and corresponds to the next higher ARIT of the relational multi-level tree system;
pre-sorting, by the processor, the contributing entities' position assignments in the relational multi-level tree system based on age ordered priorities;
determining, by the processor, optimal sizes of the flat-top multi-level trees and number of the adjacent flat-top multi-level trees required to be constructed within the respective ARIT based on a total number of the contributing entities to be positioned inside respective ARITs with optimal size and measurement considerations made in accordance with a level strength analysis chart (LSAC) constructions, wherein the optimal sizes of the flat-top multi-level trees are differences between two selected levels of accumulative strengths parameters form the LSAC;
applying, by the processor, top/down assignment of the positions of the contributing entities for constructing the flat-top multi-level trees within the respective ARITs;
applying, by the processor, adjacent-top/down assignment of the positions of the contributing entities for constructing the adjacent flat-top multi-level trees within the respective ARITs;
applying, by the processor, periodically reassigning the positions of the contributing entities into the next higher ARIT of the relational multi-level tree system at interval indications or during contributing entities' age advancements;
applying, by the processor, periodically graduating the contributing entities out of the respective ARITs in the relational multi-levels tree system where, one or more contributing entities' age exceed each level of ARIT in the age ranges tabulation data structure; and
according, by the processor, fair distributions to respective contributing entities based on a contributing strength of a contributing entity and a contributing weight of a contributing entity.

2. The structured method of claim 1 wherein the ARITs are defined above a threshold age, wherein the threshold age is a variable if not 17 years old.

3. The structured method of claim 1, wherein a value of the levels of the age ranges tabulation data structure of the relational multi-level tree system is a variable if not comprises eight (8) levels of ARITs, wherein the age ranges tabulation data structure comprises:
the first level corresponds to age range of 18-26;
the second level corresponds to age range of 27-35;
the third level corresponds to age range of 36-44;
the fourth level corresponds to age range of 45-53;
the fifth level corresponds to age range of 54-62;
the sixth level corresponds to age range of 63-71;
the seventh level corresponds to age range of 72-80; and
the eighth level corresponds to age range of 81-90.

4. The structured method of claim 1 wherein the optimal size and measurement considerations made in accordance with the LSAC comprises determining and selecting an optimal level with corresponding level strength and level accumulative strength parameters using a LSAC constructions.

5. The structured method of claim 4 wherein a value of a level strength parameter of a level z in the LSAC is a variable if not based on 5z, wherein the LSAC comprises:
for level 0, strength=1 and accumulative strength=1;
for level 1, strength=5 and accumulative strength=6;
for level 2, strength=25 and accumulative strength=31;
for level 3, strength=125 and accumulative strength=156;
for level 4, strength=625 and accumulative strength=781;
for level 5, strength=3,125 and accumulative strength=3,906;
for level 6, strength=15,625 and accumulative strength=19,531;
for level 7, strength=78,125 and accumulative strength=97,656;
for level 8, strength=390,625 and accumulative strength=4,88,281;
for level 9, strength=1,953,125 and accumulative strength=2,441,406;
for level 10, strength=9,765,625 and accumulative strength=12,207,031;
for level 11, strength=48,828,125 and accumulative strength=61,035,156; and
for level 12, strength=244,140,625 and accumulative strength=305,175,781.

6. The structured method of claim 1 comprising:
determining the contributing strength of a contributing entity; and
determining the contributing weight of a contributing entity.

7. The structured method of claim 6, wherein the contributing strength of a contributing entity in the relational multi-level tree system is a variable if not five (5), and wherein the contributing weight of a contributing entity in the relational multi-level tree system is a variable if not two (2).

8. The structured method of claim 1, wherein the flat-top multi-level trees in the respective ARITs are constructed based on the size and measurement considerations made in accordance with the LSAC constructed to prevent the sizes of multi-level trees from getting overly large, and wherein the flat-top multi-level trees for positioning contributing entities in the respective ARITs are constructed based on the level strength parameters of the two selected levels from the LSAC constructed based on the size and measurement considerations.

9. The structured method of claim 1 wherein pre-sorting the contributing entities' positions assignments in the relational multi-level tree system into an ordered age priority sequence is based on priority to oldest or youngest age in accordance with birth-date and birth-time, taking into consideration timings of the contributing entities' registration clocking indicators, and wherein a unique assignment serial number is assigned to each contributing entity's position during the pre-sorting for verification.

10. The structured method of claim 1 wherein:
the contributing strength of a contributing entity is a number of collective child contributing entities assigned to each contributing entity per child level;
the contributing weight of a contributing entity is a number of levels of child contributing entities assigned to each contributing entity; and
the number of child contributing entities assigned to each contributing entity is x^{y}+x^{y-1}+x^{y-Z}+ . . . +x¹, wherein x is the contributing strength of a contributing entity and y is the contributing weight.

11. The structured method of claim 10, wherein the number of flat-top or adjacent flat-top multi-level trees to be constructed inside respective ARITs of the relational multi-level tree system is based on the total number of contributing entities to be positioned inside the respective ARITs, wherein the number of flat-top or adjacent flat-top multi-level trees to be constructed inside the respective ARITs of the relational multi-level tree system is obtained by dividing the total number of contributing entities to be positioned inside the respective ARITs with the difference between the two selected levels of accumulative strengths from the LSAC based on the size and measurement considerations.

12. The structured method in claim 11 wherein the assignment of the contributing entities into their respective positions in a single flat-top multi-level tree comprises:
assigning a number of prioritized contributing entities in the ordered age priority sequence in the respective ARIT into positions in a first level of the flat-top multi-level tree from left to right, wherein the number of prioritized contributing entities equals to the level strength of one of the two selected levels in the LSAC; and
assigning the contributing entities to every contributing entity in a previously assigned level in a top-down manner until each contributing entity in the respective ARIT is assigned a position.

13. The structured method in claim 12 wherein the assignment of the contributing entities into their respective positions into the adjacent flat-top multi-level trees comprises:
after assigning the number of the prioritized contributing entities in the ordered age priority sequence in the respective ARIT into positions from left to right in the first level of a previously assigned flat-top multi-level tree, moving across to a next adjacent flat-top multi-level tree, assigning the number of prioritized contributing entities in the ordered age priority sequence in the respective ARIT into positions in a first level of the next adjacent flat-top multi-level tree from left to right, wherein the number of prioritized contributing entities equals to the level strength of one of the two selected levels in the LSAC; and
moving back to the previously assigned flat-top multi-level tree to continue to assign the contributing entities to every contributing entity in a previously assigned level according to a determined contributing strength of a contributing entity in a top-down manner until each contributing entity in the respective ARIT is assigned a position.

14. The structured method of claim 1 comprises periodically reassigning positions of contributing entities into a next higher ARIT of the relational multi-level tree system based on interval indications if not during contributing entities' age advancements, wherein one or more contributing entities' ages exceed each interval level of the age ranges tabulation data structure, and the one or more contributing entities are graduated out of respective ARITs in the relational multi-level tree system, and wherein the according of fair distributions is based on the contributing strength of a contributing entity and the contributing weight of a contributing entity.

15. A relational multi-level tree system for effecting fair distributions to contributing entities positioned in the relational multi-level tree system, comprising:
a database providing entity information of the contributing entities, wherein the entity information includes age information of the contributing entities and other information that is useful to schedule fair distributions;
a processor configured to
define an optimal number of ARITs corresponding to levels of an age ranges tabulation data structure of the relational multi-level tree system, wherein the relational multi-level tree system comprises flat-top or adjacent flat-top multi-level trees in the age ranges tabulation data structure,
pre-sort the contributing entities based on the age information in the database to form an ordered age priority sequence of contributing entities' positions in the relational multi-level tree system,
assign, using the ordered age priority sequence, the pre-sorted contributing entities in their respective ARITs which correspond to the levels in the age ranges tabulation data structure by assignment of the positions of the contributing entities into the flat-top or adjacent flat-top multi-level trees in accordance with use and guidance by a level strength analysis chart (LSAC) constructed, wherein the LSAC includes level strength and level accumulative strength parameters for size and measurement considerations, and wherein assigning the pre-sorted contributing entities in the respective ARIT comprises
determining an optimal size of the flat-top multi-level tree and the number of adjacent flat-top multi-level trees required to be constructed within the respective ARIT based on a total number of contributing entities to be positioned in the respective ARIT with optimal size and measurement considerations made in accordance with the LSAC, wherein the optimal size of the flat-top multi-level tree is a difference between accumulative strengths of two selected levels in the LSAC, and wherein the number of the flat-top and adjacent flat-top multi-level trees required to be constructed within the respective ARIT is computed by dividing the total number of contributing entities to be positioned in the respective ARIT by the optimal sizes of the flat-top multi-level tree,
constructing a single flat-top multi-level tree or multiple adjacent flat-top multi-level trees within the respective ARIT based on the optimal size of the flat-top multi-level tree and number of adjacent flat-top multi-level trees required to be constructed within the respective ARIT, and
assigning the contributing entities into their respective positions in the single flat-top multi-level tree or multiple adjacent flat-top multi-level trees in the respective ARIT by applying top/down or adjacent-top/down assignment of positions of contributing entities respectively;
periodically release and reassign contributing entities' positions into a next successive higher position in the age ranges tabulation data structure of the relational multi-level tree system during a position assignment reprioritizing process, based on interval indications or during contributing entities' age advancement, wherein one or more contributing entities are graduated out of the relational multi-level tree system in the event the one or more contributing entities' age exceeds the defined ARITs; and
perform fair distributions to the contributing entities based on their age-ordered assigned positions in the relational multi-level tree system.

16. The system of claim 15, wherein a number of the levels of the age ranges tabulation data structure of the relational multi-level tree system is a variable if not comprises eight (8) levels of ARITs, wherein the age ranges tabulation data structure comprises:
the first level corresponding to age range of 18-26;
the second level corresponding to age range of 27-35;
the third level corresponding to age range of 36-44;
the fourth level corresponding to age range of 45-53;
the fifth level corresponding to age range of 54-62;
the sixth level corresponding to age range of 63-71;
the seventh level corresponding to age range of 72-80; and
the eighth level corresponding to age range of 81-90.

17. The system of claim 15, wherein a value of a level strength parameter of a level z in the LSAC is a variable if not based on 5z, wherein z is from 0 to 12, wherein the LSAC comprises:
for level 0, strength=1 and accumulative strength=1;
for level 1, strength=5 and accumulative strength=6;
for level 2, strength=25 and accumulative strength=31;
for level 3, strength=125 and accumulative strength=156;
for level 4, strength=625 and accumulative strength=781;
for level 5, strength=3,125 and accumulative strength=3,906;
for level 6, strength=15,625 and accumulative strength=19,531;
for level 7, strength=78,125 and accumulative strength=97,656;
for level 8, strength=390,625 and accumulative strength=4,88,281;
for level 9, strength=1,953,125 and accumulative strength=2,441,406;
for level 10, strength=9,765,625 and accumulative strength=12,207,031;
for level 11, strength=48,828,125 and accumulative strength=61,035,156; and
for level 12, strength=244,140,625 and accumulative strength=305,175,781.

18. The system of claim 15, wherein pre-sorting the contributing entities' positions in the relational multi-level tree system into an ordered age priority sequence is based on priority to oldest or youngest age in accordance with birth-date and birth-time, taking into consideration timings of the contributing entities' registration clocking indicators, wherein a unique assignment serial number is assigned to each contributing entity's position during the pre-sorting for verification.

19. The system of claim 15 comprises periodically reassigning positions of contributing entities into the next higher ARIT of the relational multi-level tree system based on interval indications or during contributing entities' age advancements, wherein one or more contributing entities' ages exceed each interval level of the age ranges tabulation data structure and the one or more contributing entities are graduated out of respective ARITs in the relational multi-levels tree system, and wherein the according of fair distributions is based on the contributing strength of a contributing entity and the contributing weight of a contributing entity.
